(19) United States
(12) Patent Application Publication
(10) Pub. No.: US 2016/0343043 A1
(43) Pub. Date: Nov. 24, 2016

(54) System and Method for Charitable Giving

(71) Applicant: PlanG Holdings Inc., Richmond, VA (US)

(72) Inventors: Heather Loftus Hicks, Richmond, VA (US); Marti Lee Lazear, Richmond, VA (US); Melina Davis-Martin, Richmond, VA (US)

(21) Appl. No.: 15/226,692

(22) Filed: Aug. 2, 2016

Related U.S. Application Data
(63) Continuation of application No. 14/616,836, filed on Feb. 9, 2015, now abandoned.
Application No. 14/616,836 is a continuation-in-part of application No. 13/711,699, filed on Dec. 12, 2012, now abandoned.
(60) Provisional application No. 61/569,331, filed on Dec. 12, 2011.

(51) Int. Cl. G06Q 30/02; G06F 3/0484; G06Q 20/10

(52) U.S. Cl. CPC G06Q 30/0279; G06Q 20/10; G06F 3/04842

(57) ABSTRACT

A computerized processing method and system for managing charitable donations and providing a giving lifecycle for the donor. The method and system includes granting a donor electronic access to a giving account, wherein the giving account includes a plurality of donation funds. The method and system include electronically receiving a donation request from the donor to generate a donation to a user-selected charity from a plurality of charities, the donation providing a donation value of at least a portion of the donation funds within the giving account. The method and system include processing the donation including transferring the donation value to the selected charity, updating the donation account of the donor to reflect the allocation of donation funds, and providing a graphical user interface to the user including types of charitable donation causes by the user within a defined time period.

### RELATED APPLICATIONS

The present application is a continuation of U.S. application Ser. No. 14/616,836 filed on Feb. 9, 2015, which is a continuation-in-part of U.S. application Ser. No. 13/711,699 filed on Dec. 12, 2012, now abandoned, which claims the benefit of priority to U.S. Provisional Patent Application Ser. No. 61/569,331 entitled SYSTEM AND METHOD FOR CHARITABLE GIVING filed on Dec. 12, 2011, all of which are hereby incorporated by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

The present invention relates generally to charitable donations and more specifically to an electronic processing system and user interface for managing and coordinating charitable donations between donors and charities.

### BACKGROUND

Typical charitable giving is a complicated and inefficient process. One technique includes a donor actively searching for a suitable or ideal charity to which to give donations. The donor must undertake a searching process to find a suitable charity, including reviewing the goals and objectives of the charity compared with the user's personal interests for donating. This can be a cumbersome process for a person seeking to make a donation.

Another technique is for a charity to be actively searching for donations by seeking out potential donors. This may be via a generalized donation campaign providing a mass-targeting approach. This may be via a donor coordinator system whereby leaders help solicit donations from donors, such as neighbors, co-workers, shoppers entering a local store, etc.

There are also existing electronic techniques for coordinating donations. For example, various charities include particular events and participants raising funds for the event. The participants may have a website for themselves, as well as their team. The participant can then generate electronic communications to direct others to contribute to the charity on the participant's behalf via the website. The site can then track the participant's progress towards a defined charity goal, as well as the participant's team progress. These sites include other features for facilitating electronic giving, including an electronic wall to leave messages, the ability to efficiently join the participant's team or even share the information with social media sites.

Another existing technique for charitable giving includes coordination of giving techniques with point of sale transactions. For example, U.S. Pat. No. 8,160,922 provides for the inclusion of a charitable donation for a user directly via a point of sale transaction. This technique is limited to point of sale scenarios. Where existing technology fails the well-intended individual is providing an environment or processing lifecycle not only for single giving transactions, but ongoing giving efforts. Existing systems focus on unitary transactions for the charity and/or unitary fundraising efforts for a single goal for the charity. These systems fail to intimately integrate the donor with the recipient, tie the donor's goals and motivations for giving with the proper charitable organization, and provide a central platform for seamlessly donating and tracking a lifetime of giving activities. Thus, there exists a need in the art for a system and method that provides for charitable giving via a centralized platform. There is a need for the platform to facilitate coordination of donors and recipients, as well as better manage the donor's activities and intents.

### SUMMARY OF THE INVENTION

A computerized system and method for managing charitable donations of a donating user, the system embodiments having a non-transitory computer readable medium storing executable instructions and a processing device, which in response to the executable instructions, operate to implement the computer processing method for managing such charitable donations. In some embodiments, the method (or computer processing method) involves the steps of providing a graphical user interface to the user by a computerized gift processing system, wherein the gift processing system comprises an influence engine, creating within the gift processing system a giving account for that user and granting the user electronic access to this giving account within the graphical user interface. The graphical user interface may also display a plurality of charities. The method may involve receiving (by the computerized gift processing system) a first plurality of donation funds from the user for allocating to the giving account of the user. Upon allocation, the giving account will then include the first plurality of donation funds. The system and method may then electronically receive in the computerized gift processing system a donation request from the user to generate a donation to a user selected charity from the plurality of charities, with the donation providing a donation value of at least a portion of the first plurality of donation funds within the giving account. Included may be the steps of electronically processing the donation, such as transferring, via the computerized gift processing system, the donation value to the selected charity; and updating the giving account of the user to reflect the allocation of donation funds to the selected charity.

The method may include the steps of collecting donation activity information of the user; scoring the donation activity information of the user; and determining via the influence engine a donor influence rating as a function of the scored donation activity information. In some embodiments, the donor influence rating may be determined by a weighted logarithmic sum. In other embodiments, the system and method may facilitate electronic engagements (such as communications, or charity related efforts) between the user and the selected charity, via the graphical user interface. Donation activity information about the user may include information about the electronic engagements between the user and the selected charity. The plurality of charities displayed in the graphical user interface may include at least one recommended charity, which can be determined as a function of the donation activity information of the user, or by other information.

The system and method can be extended to a user's transactions or other interactions with third parties. In some embodiments, the method may involve providing a processing module to a third-party having a commercial transaction web interface. A processing module may enable the user to access a portion of the graphical user interface of the gift processing system from the third-party's commercial transaction web interface. For example, a user shopping at a third-party's e-commerce store may be able to use the interface of the e-commerce store to initiate a donation as part of the commercial transaction. The system and method would be operable to receive this second plurality of donation funds from the user when the user performs the processing transaction on the third-party commercial transaction web interface; at which point, the giving account would also include the second plurality of donation funds. The system and method may then electronically receive (in the computerized gift processing system) a donation request from the user to donate to its selected charity. Then the donation may represent a donation value from of at least a portion of the first and second plurality of donation funds within the giving account. In that third-parties may be able to improve or tailor commercial transactions or other services for users, the system and method may involve providing the donor influence rating to the third-party. A third party may also use the system and method to supply at least a portion of the second plurality of donation funds on the user's behalf, possibly as a matching or fundraising campaign for a particular charity or charity of the user's choice.

The user may thus derive donations funds from a variety of sources. In a direct embodiment, the system and method may receive of the first plurality of donation funds for allocation to a user's giving account by electronic transfer from a bank account associated with the user. Alternatively, in an indirect embodiment, the donation funds may be supplied by a third-party via one or more third-party reward accounts offered by the third-party to the user. In some cases, a plurality of donation funds may be sourced from the user for allocation to the giving account of the donor by electronic transfer from an employer of the user. It is contemplated that the third-party may not be a financial services provider and that the commercial transaction web interface may very well be an offline retail transaction, or a transaction by a retail electronic commerce website, including those processing commercial transactions via the web interface for the online purchase by user of a product.

However, the system and method are not so limited. Embodiments may extend to computerized systems and methods for managing charitable donations from a donating user, similarly involving in system embodiments a non-transitory computer readable medium having executable instructions stored thereon; and a processing device, in response to the executable instructions, are operable to implement the methods and processes described herein. In some embodiments, the processor may be operable to (or, as a method, include corresponding steps to) provide a graphical user interface for access to a computerized gift processing system, wherein the gift processing system comprises an influence engine; display within the graphical user interface a plurality of charities; provide a processing module to a third-party for use in a commercial transaction with the user, the processing module enabling the user to access at least a portion of the graphical user interface of the gift processing system; receive by the gift processing system a first plurality of donation funds from the user via the user performing a processing transaction with the processing module, such that the giving account includes the first plurality of donation funds; electronically receive in the computerized gift processing system a donation request from the user to generate a donation to a user-selected charity from the plurality of charities, the donation providing a donation value of at least a portion of the first plurality of donation funds within the giving account; electronically process the donation including transferring, via the computerized gift processing system, the donation value to the selected charity; update the giving account of the user to reflect the allocation of donation funds to the selected charity; collect donation activity information of the user; score the donation activity information of the user; and determine via the influence engine a donor influence rating as a function of the scored donation activity information by a weighted logarithmic sum.

In other embodiments of the system (and method), the system is operative to provide the user access to the graphical user interface without use of the processing module; create within the gift processing system a giving account associated with the user and grant the user electronic access to the giving account via the graphical user interface; receive by the computerized gift processing system a second plurality of donation funds from the user for allocation to the giving account of the user, such that the giving account includes the first and second plurality of donation funds; and electronically receive in the computerized gift processing system a donation request from the user to generate a donation to a user-selected charity from the plurality of charities, the donation providing a donation value of at least portion of the second plurality of donation funds within the giving account. Optionally, it may be further operative to provide the donor influence rating to the third-party, or the commercial transaction may specifically be an offline purchase by user of a product.

The present approach provides a computerized processing method and system for managing charitable donations and providing a giving lifecycle for the donor. The method and system includes granting a donor electronic access to a giving account, wherein the giving account includes a plurality of donation funds. The method and system includes electronically receiving a donation request from the donor to generate a donation to a selected charity from a plurality of charities, the donation providing a donation value of at least a portion of the donation funds within the giving account. The method and system includes processing the donation including transferring the donation value to the selected charity, updating the donation account of the donor to reflect the allocation of donation funds, and providing a graphical user interface to the user including types of charitable donation causes by the user within a defined time period.

The method and system provides further enhancements for the user, also referred to as donor, and ensuring not only an optimal donation process, but a continued relationship between the donor and various charitable organizations. The donation of funds to the user's giving account may be provided from any number of sources, including for example via a bank transfer from the user's banking account directly transferring funds to the giving account. In another example, the user may electronically transfer rewards or points from various commercial vendors, such as credit card vendors, airline miles, loyalty program currency, etc. In another embodiment, the user may be provided the ability to generate donations via an employer payroll or employee benefit system, such as having funds automatically withdrawn from the user's paycheck and then seamlessly transferred to the user's giving account via the employer's payroll system.

In another embodiment, the inclusion of a donation module or third-party interface can allow for the user to perform giving operations concurrent with online transactions with various websites. While one example may be the inclusion of a donation link on a charity's website, other examples include the inclusion of donation links for a commercial website's preferred or affiliated charity. Thus, the user can perform donation activities via the donation platform while interacting directly on a third-party website. The system and method further provides additional benefits to the user for managing donations, including managing communications between the user and the user's charities. The user may be presented with similar or like-minded charities via the associate of charities into distribution partners. The user may be presented with a graphical user interface providing illustrations of the user's contributions, volume of contributions and types of charities receiving said contributions. The user may also receive tax or other reporting information for defined time period, such as the end of a calendar year. These and further advances and improvements provided by the system and method for charitable giving are described below.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a processing system providing for charitable giving, while FIG. 2 illustrates another embodiment of a processing system providing for charitable giving;

FIG. 3 illustrates a flowchart of one embodiment of a method for charitable giving;

FIG. 4 illustrates a graphical representation of a charitable giving cycle utilizing the charitable giving processing system;

FIG. 5 illustrates a flowchart of the steps of embodiments for the processing and in-flow of donation funds using the charitable giving processing system, and FIG. 6 illustrates a flowchart of the steps of embodiments for the processing and out-flow of donation funds using the charitable giving processing system;

FIG. 7 illustrates a representation of one embodiment of multi-party interaction with the charitable giving system;

FIGS. 8-12 are representative screenshots of various embodiments of the user interface for the charitable giving system, and FIG. 13 illustrates a model for determining an influence rating.

### DETAILED DESCRIPTION

In the following description, reference is made to the accompanying drawings that form a part hereof, and in which is shown by way of illustration specific embodiments in which the invention may be implemented. It is to be understood that other embodiments may be utilized and design changes may be made without departing from the scope of the present invention.

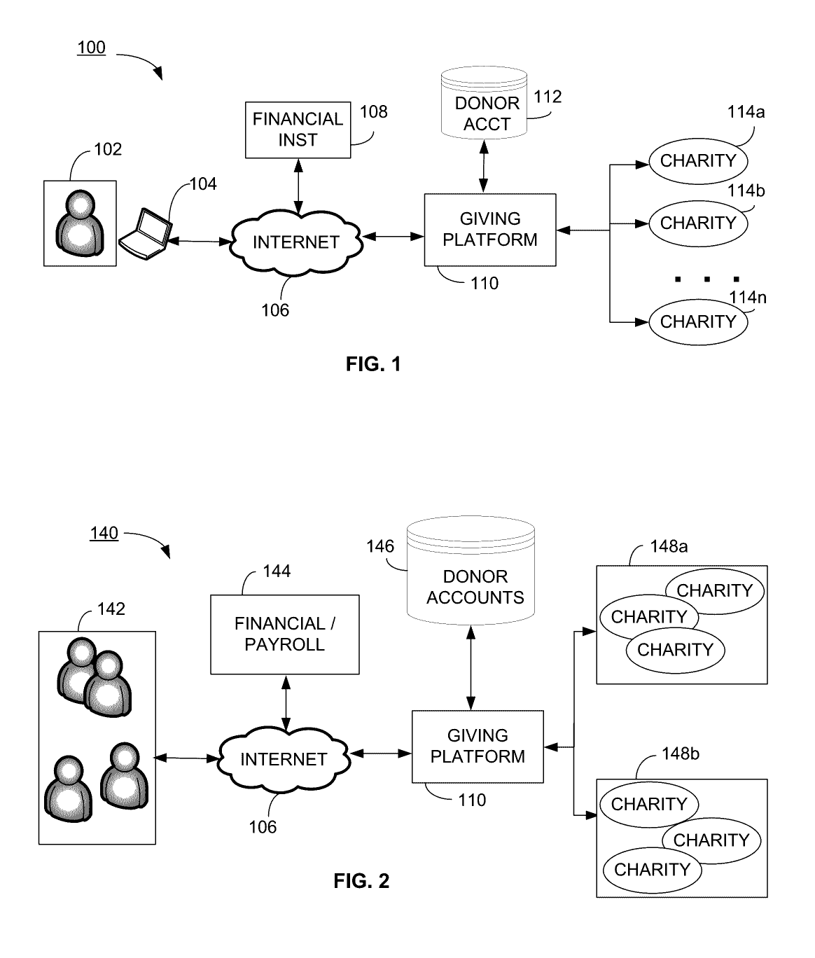

As described herein, methods and processing systems for charitable giving improve not only the giving the process, but donor access to charitable organizations and management of organizational access to its donors. In one embodiment, FIG. 1 illustrates a generalized processing system 100 including a user 102, a user computing device 104, a network 106, financial institution 108, a giving platform 110, donor account database 112 and a plurality of charities 114a -114n, where n is any integer value.

The user 102, also referred to herein as a donor, may be one or more users interacting or interfacing with the system 100 as described below. The computing device 104 may be any suitable processing device including a desktop or laptop computer, a mobile phone or smart phone, a tablet computer, a video game controller, a television interface or set-top box controller, or any other suitable stationary or mobile processing device or devices providing for user interactivity as described below.

The network 106 may be any suitable network, including wired and/or wireless network(s). For example, the network 106 may be the Internet, but can also be a private network, or combination of networks, including a wireless network for mobile access to the Internet and routing of communications thereacross.

The financial institution 108 represents any suitable type of financial processing or financial data storage facility. In one embodiment, the financial institution 108 may be an online banking facility providing for electronic transfer of cash or other financial resources. It is recognized that the financial institution may be any suitable type of financial processing operation or facility and is not expressly limited to a bank, but can include other exemplary processing facilities such as an employee payroll system, a micro-lending or financial crowd-sourcing web location, or any other suitable system.

The giving platform 110 may be, incorporate, or use one or more processing devices performing processing operations as described herein. The processing device(s) operate in response to executable instructions provided from non-transitory computer readable medium (not expressly illustrated). The processing devices may be in a single processing environment, or may be within a distributed computing environment.

The donor account database 112 is one or more data storage devices storing donor account information. As described in further detail below, the donor account information provides for user account information, as well as preferences, charitable donation history, connections and relationships with other users and charities, contact preferences, financial information, and other data.

The charities 114a -114n (collectively referred to as charity 114), may be any suitable type of non-profit or similarly situated organization. The charity may be a local charity, national charity, a collection of charities, or any other type of organization established for charitable purposes. The charity 114 illustrated herein represents the charitable organization, but as described in further detail below, the processing system may include further degrees of informational exchange and data interfacing. For example, the charity 114a may represent a computer processing interface for the charity itself, for communicating with the giving platform 110. The charity 114a may include computer processing facilities for active engagement and data exchange. In another example, the charity 114b may represent a static data file providing information to the giving platform about the charity, such as its purpose and intended beneficiaries.

In one embodiment, the user 102 accesses the giving platform 110 via the network connection 106 using the mobile computing device 104. The user 102 accesses financial institution data 108 for performing giving operations via the platform 110. In one embodiment, the user 102 may populate the donor account 112, including entering user information such as name, age, preferences, personal goals, charitable goals, charitable giving history, preferred charities or causes and financial information. The user 102 may also effectuate the transfer of donation funds to the donor account. These donation funds may be real dollars from the financial institution 108, or as described in further detail below, can be other forms of donations, including customer loyalty points, airline miles, etc.

Via the giving platform 110, the user 102 can then perform any number of account management and charitable activities. For example, the user 102 may perform searching operations to select a charity from an unlimited or predetermined set of charities. In this embodiment, the platform 110 may utilize the user's account information 112 or ask a series of questions directed to matching the user with a particular charity of relevance. The platform 110 can suggest or highlight one or more recommended charities 114 based on a comparison of the user's activity, preferences, or goals, with the purposes of the various charities 114. The recommendation may be based on a combination of factors, such as a weighted metric of preferences (e.g., a partner's recommendation), location, likelihood of selection, charity rating, etc. When a connection is then made, the user 102 is presented the opportunity to make a donation.

Further embodiments, additional functionality and additional interactivity of the giving platform are described herein. For example, FIG. 2 illustrates another embodiment of a computerized gift processing system 140 including a plurality of users 142 (also referred to as donors), the network connection 106, financial/payroll system 144, the giving platform 110, a donor account storage device 146 and distribution partners 148a and 148b.

The users 142 (or donors), may be a collection of individuals grouped together by a commonality. In one embodiment, they may all be employees for the same company or members in the same group. Omitted for the sake of brevity in FIG. 2 is the processing device 104, but it is recognized that the group 142, as well as the individual donors may access the giving platform using any suitable processing device.

The financial/payroll system 144 may be a computerized processing system for computing and processing financial and/or payroll information for the donors 142. In the example of the donors 142 being employees, the payroll system 144 may be the employer's payroll system, whether performed internally or outsourced to a third-party. The payroll system 144 can process payroll information for the donors, as well as allocate a portion of payroll for distribution to the giving platform 110. Similarly, if the donor users 142 are group members, the system 144 may process membership dues, such as using processing operations similar to the above-described financial institution processing device 108 of FIG. 1.

Whereas the memory device 112 of FIG. 1 stored a single donor or giving account, the device 146 provides for the storage of account information for numerous donor users 142 within the group. The memory may be central or distributed memory with various amounts of data stored therein. Similar to the donor data described above with regards to FIG. 1, this data in the donor accounts 146 may additionally include data coordinating the donation funds with a payroll system, such as indicating funds as being taxable, employer-matching capabilities, or other features.

Also illustrated in this embodiment is the utilization of distribution partners 148a and 148b. While two examples of distribution partners are illustrated, it is recognized that any number of partners may be utilized and are within the scope of this invention. The distribution partner 148 provides a commonality or a collection of charities for the ease of donor participation. For example, smaller charities may not have sophisticated donation processing capabilities, or may lack marketing budgets to generate much-needed revenue. The inclusion of partners 148 can help facilitate this giving by grouping charities based on causes, so for example if a donor seeks to give donations to a charity that provide care and rescue of animals, the donor may only know of nationally-known charities. But the donor can be presented with the opportunity to donate to various local charities offering pet rescue and adoption services based on these local charities being within the grouping 148.

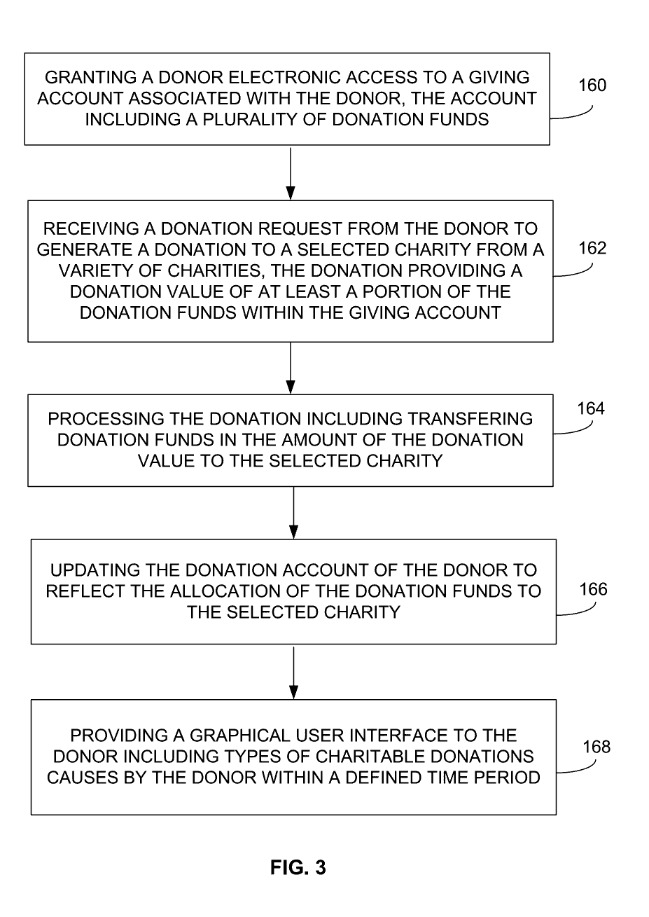

FIG. 3 illustrates a flowchart of one embodiment of a method for managing charitable donations. The steps of the flowchart represent one exemplary embodiment and are not limiting in nature. Moreover, the computerized processing operations may be performed by the giving platform 110 in the systems 100 and/or 140 described above.

In this embodiment, a first step, step 160, is granting a donor user electronic access to a giving account that the system associates with the donor user, the giving account including a plurality of donation funds when provided by the user. For clarity, the giving account is an account of the gift processing system, and not a source financial account of the user. This first step may be electronically performed by the giving platform 110 granting access to account information stored in the database 112 or database 146 in FIGS. 1 and/or 2.

A next step, step 162, is receiving a donation request from the user to generate a donation to a user selected charity from a variety of charities, the donation providing a donation value of at least a portion of the plurality of donation funds within the giving account. As noted above, the donor user can donate actual monetary funds, e.g. US dollars, or may donate other forms of donation currency. Other forms may include, but are not limited to, loyalty reward points, airline miles or other forms of credits or rebates. In this case, the donor user may make a donation selection via the graphical user interface provided by the system of the giving platform 110, including the selection of one or more charities 114 and a designation of the amount to be donated. Donation funds may for a user may come from a variety of sources, including third-parties, in which case there may be a donation of a first and second plurality of donation funds.

A next step, step 164, is the processing of the donation including transferring the donation funds in the amount of the donation value to the selected charity. Via the giving platform 110, this step may be accomplished by the electronic transfer of funds using a funds-processing clearinghouse or any other suitable type of intermediary. In one embodiment, the platform 110 may include a processing fee or other type of transaction fee to defray operational costs, as necessary.

A next step, step 166, is updating the donation or giving account of the donor user to reflect the allocation of the donation funds to the selected charity. This step may include the giving platform 110 updating the giving account information stored within the database 112 or 146 in FIG. 1 or 2 above.

In this embodiment, step 168 may be providing a graphical user interface to the user including types and amount of charitable donations by the user within a defined time period (i.e., a portion of the user's donation activity). In one embodiment, the time period may be during a calendar year, illustrating the value of donations made by the donor user during the year, for example, including illustrating the types of donations and associated values. For example, the donor user could donate airline miles to a charity that flies deployed U.S. Service members home for special occasions, the donor user could also donate pet store loyalty reward points to an animal rescue league and then donate actual money to a local homeless shelter. The platform 110 therein provides an interface that illustrates these different donation totals, including amounts and types of charities to which the donations have been granted.

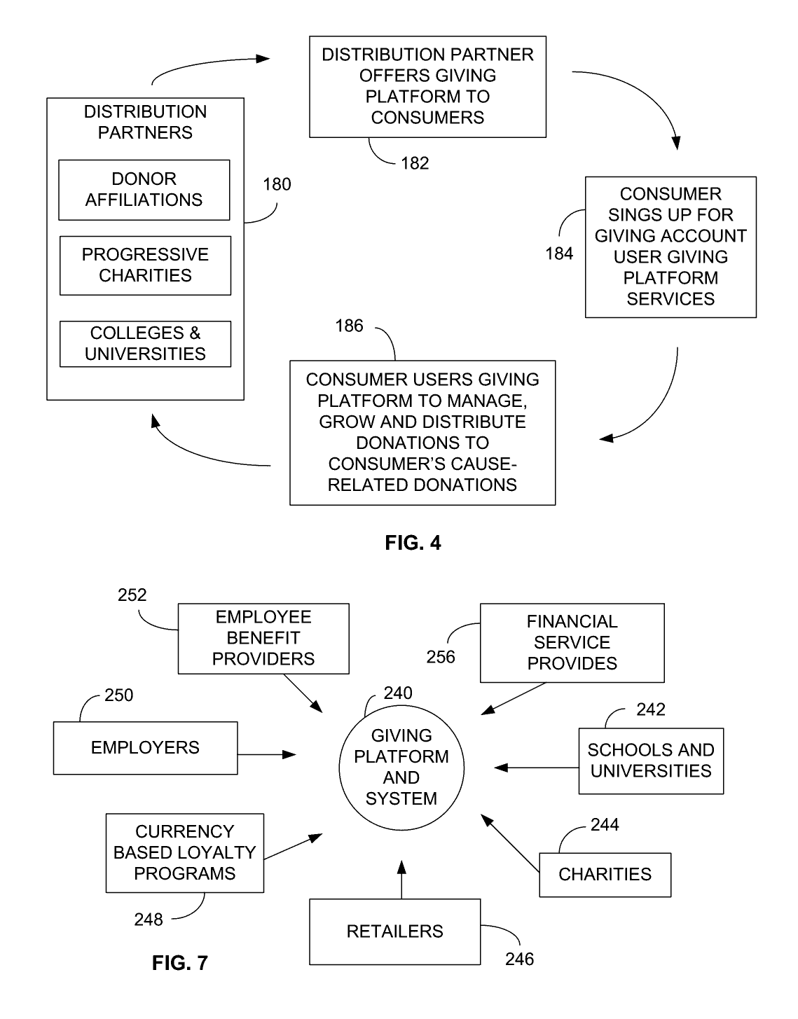

FIG. 4 illustrates a graphical representation of the donation lifecycle, as enabled by the method and system for managing charitable donations. In this system, there are numerous distribution partners 180. As described above, these distribution partners can represent any number of charities or other non-profit organizations, whether by affiliation or other type of grouping. In the example of FIG. 4, there are 3 listed examples of partnerships, donor affiliations, progressive charities and colleges and universities (sometimes generically referred to as charities). These distribution partners connect and/or coordinate with the giving platform for presentation of charitable purposes, e.g. marketing, as well as to be connected with donors.

In this lifecycle, a second element or aspect may be the distribution partners offering a giving platform to their consumers to become users, 182. This may be accomplished by the distribution partners engaging the giving platform, including in one embodiment providing invitations, such as electronic invitations via an embedded hyperlink, applet, java script, or other processing module, to the giving platform to potential donor users. Processing modules may also include other offline elements by which users may subsequently access the system via a graphical user interface, such as promotion codes, data on gift cards or receipts, quick response codes, bar codes, or other offline tools, etc.

In this cycle, a next step, step 184, is the consumer user signs up for a giving account using the giving platform services. In one embodiment, this may include the user employing the system for generating a new giving account with the giving platform, such as entering a username, password, personal information and possibly a donation account source information. Wherein the user has an existing account, the user may simply log in to the existing account. The user may also enter preference information relating to the user's preferences for charitable giving, such as preferred charity organizations. With the registered account, the consumer becomes a user and a potential donor.

In this cycle, a next step 186 is that the consumer/user/donor uses the giving platform to manage, grow and distribute donations to intended cause-related charities. The donor can select these cause-related charities via the platform, including the utilization of the distribution partners 180. Thus, with the donations, the distribution partners are able to continue the cycle of FIG. 4 to steps 182, 184 and 186, thus increasing not only the amount of donation funds raised, but also providing a centralized platform for many donors to facilitating their giving activities.

In one aspect, embodiments of the giving platform, system, and method allow for users to give the gift of giving. This embodiment may include executable instructions allowing for a user to make a gift card or donation amount purchase. The purchase itself generates a gifting amount that can be given to a recipient. That recipient then can utilize the giving platform to donate the donation amount. In a typical embodiment, the recipient therein selects a cause or charity for giving the donation, or in another embodiment, the user can pre-designate the donation amount and/or charity.

In one embodiment, the user, employer, or third party may purchase an actual physical gift card that can be mailed to the user, or otherwise delivered to the recipient. One technique allows the recipient to enter an identification number or other code into the giving platform (i.e., via the systems graphical user interface) to activate or acknowledge receipt of the gift card. The recipient user may also have a giving account, or can generate an account via the graphical user interface. The recipient then selects or designates the intended charity for receipt of the donation and funds are properly transferred from the gift card, for example, to the giving account of the gift processing system, and then to the selected charity. In another embodiment, the gift card itself may be an electronic transaction stored and managed within the giving platform. The user may enter a recipient email address and the recipient may receive an email or other communication indicating the gifting credit on the platform, instead of using a physical delivery technique.

Optionally, the giving platform further manages accounting for taxable benefits, in the event the user giving the gift or the recipient is eligible for tax benefits for the donation. The giving platform may further coordinate with other services for enhanced charitable contributions, such as social media announcements, coordinating the recipient with the charity for further communication, or other features described herein.

Another aspect of the giving platform is the coordination and integration of the act of giving with commercial activities. Commercial activities generally refer to online commercial activities between users and third-parties, either offline or having their own third-party commercial transaction web interface. This phrase is not intended to refer to a party's routine banking transactions, such as a conventional withdrawal or transfer of funds from an existing account, for example. However, it is intended to refer to a party's purchase of an item, such as a cash card intended as a graduation gift, for example. As described herein, there are programs for loyalty rewards and point of sale transactions that allow for the transfer of donation funds into the giving account of the gift processing system. In other words, a plurality of donation funds received by the system for a user's giving account may originate from a variety of sources. An aspect to the giving platform is the simplified participation of third-party businesses interested in contributing dollars to a user's giving account in exchange for the user's response to promotions and incentive campaigns. Such promotions and incentive campaigns may include promotional offers as described herein, and may be visible in the sample screenshots noted below. For example, a business may offer the exchange that a user spend $100 and gets a donation of 5% to the user's charity of choice (i.e., in this model, a user may choose from an unlimited set of charities, as opposed to a set provided by the business). The percentage of the purchase amount is then contributed to the user's giving account in the form of cash and the user may then donate the funds to the selected charity. The computerized gift processing system may thus include or provide a processing module for the third-party to incorporate into the third-party commercial transaction web interface. A user response to a promotion may perform a processing transaction that enables the user to access the gift processing system to provide donation funds to the user's giving account.

The gift processing system may collect and employ donation activity information of users to enhance user experience, provide services to third-parties, or to assist charities. For example, the giving platform may derive certain variables about the user and utilize various algorithms in order to promote the most relevant offers to the user. These may be performed using optimization algorithms recognized by one skilled in the art based on the user profile information, the user's activities histories and/or retailor profile data. The embodiment of an offer framework within the giving platform includes various offers, usage (frequency, average purchase amount), interaction of exchanges between the user and charity, location, preferences (implicit and explicit), and web analytics. The algorithms used to support the offer framework are weighted and presented to the customer based on preferences and high-response offers.

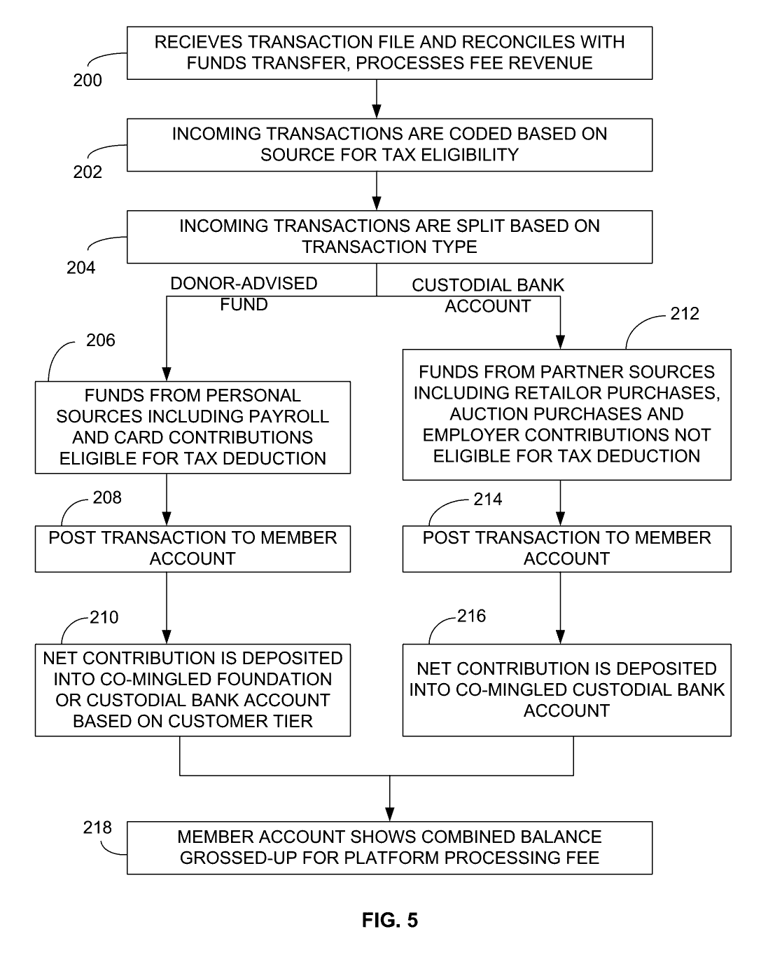

FIG. 5 illustrates a flowchart of the steps of one embodiment of a funds in-flow methodology. The following flowchart and steps represent one exemplary embodiment, wherein it is recognized that additional steps and variations of the described steps are envisioned herein. Moreover, from general processing operations, these steps may be performed by the giving platform 110 of FIGS. 1 and 2, in conjunction with associated banking or financial resources.

In a first step, step 200, the giving platform receives transaction files, reconciles with funds transfer, and processes fee revenue. In this step, the donation transactions are noted as files indicating user A providing the transfer of funds X. For accounting purposes, this transfer is then compared with and reconciled against the funds transfer operations. Moreover, the giving platform itself may recover a fee for the processing of transactions, thereby processing fee revenue. In general, funds are processed on a First-in-First-Out basis. The fees are recorded with each deposit and vary based on the type of payment option selected (Some partners may elect to cover the transaction process fees.) Fees assessed to a donation may be determined by a pro-rata fee assigned to the deposits that comprise the funds of a donation. Personal deposits of a user may carry fees based on the type of payment transaction selected, such as those of a credit card or debit car; the third party financial institutions issuing such cards may control the assessment of such fees.

In a next step, step 202, is the incoming transactions are coded based on source for tax eligibility. Different transactions have different tax treatments, such as donations made to eligible 501(c)(3) organizations are eligible for tax deductions, whereas some employer contributions, such as gift-matching, would not.

In a next step, step 204, is the incoming transactions are split based on the transaction type. In this embodiment, the transaction types may be either donor-advised funds or custodial bank accounts.

For donor-advised funds, the next step, step 206, is that the funds from the personal sources including payroll and card contributions are eligible for tax deduction status. The next step, step 208, is to post the transaction to the member account. Therein, step 210, is that the net contribution is deposited into co-mingled foundation or custodial bank account based on the customer tier, wherein various customers may be placed in tiers or levels. More prolific users/donors can be presented at a higher tier, thus being positioned for further processing capabilities and management, including a greater degree of tax and accounting measures, as well as varying forms of donation funding. By contrast, the platform may also host lower tier users who have limited donations, such as annual or one-time transactions, where lower activity of the account allows for lower accountant maintenance operations for the platform.

In the event the transaction type is a custodial bank account, the next step, step 212, is that the funds from partner sources including retailor purchases, auction purchases and employer contributions not eligible for tax deductions. In step 214, the transactions are posted to the member account and then net contributions are deposited into comingled custodial bank account, step 216.

After step 210 or step 216, depending on the transaction type being either a donor-advised fund or a custodial bank account, the next step, step 218, is the member account shows combined balance, including grossed-up for platform processing fee. The giving platform 110 can provide this balance via the user interface visible on the processing device 104, such as visible on a web-based interface, in another example an application running on a mobile platform, or in another example the user may receive a text message or email message with an account balance, or any other suitable interface to provide and display the financial account information to the user.

FIG. 6 illustrates a flowchart of one embodiment of outgoing funds accounting. The following flowchart and steps represent one exemplary embodiment, wherein it is recognized that additional steps and variations of the described steps are envisioned herein. Moreover, from general processing operations, these steps may be performed by the giving platform 110 of FIGS. 1 and 2, in conjunction with associated banking or financial resources.

In a first step, step 220, the member account shows combined balance grossed up for system fee. The combined balance indicates all donation funds in the account, including funds having been transferred therein, such as using the technique described above in FIG. 5. The system fee includes any type of fee attributes to the user for the utilization of the giving platform, wherein that fee may be a membership fee, a transaction fee, a donation percentage fee or any other suitable type of fee arrangement. There may be various fee options associated with deposits made by a partner: normal fee assessment; partner funding of a fee so that it is not assigned to the deposit; system waiver of the fee; calculation of a revenue share back to a partner based on the deposit; or assessment of a variable or fixed fee as requested by a partner.

In a next step, step 222, the member accesses the site and recommends a donation. Through the giving platform 110, the user may select one or more charities and selects said charity. The next step, step 224, is the system validates the status of the charity organization. This validation may include verification of charitable 501(c)(3) status, and may include additional steps for verification, including checking any additional charitable registrations or other forms to verify the charitable entity.

Within the giving platform, a next step, step 226, is that the gift processing system may aggregate transactions by account type. As noted above in FIG. 5, the two exemplary account types are donor-advised funds and custodial bank accounts.

For donor-advised funds, the next step, step 228, is the system sends donation transaction file to foundation on a predetermined time frame. In this embodiment, the time frame is bi-weekly, but it is recognized that any other time frame may be utilized.

A next step, step 230, is the foundation verifies charitable status and cuts a check to the recipient organizations. In this embodiment, the cutting of the check may be the actual printing and mailing of a physical check, or can include an electronic wire-transfer if the charity is able to receive such donation amounts. A next step, step 232, is that the foundation notifies the recipient organization of gross and net contribution per member. In this step, the per-user allocation of donations are then communicated to the charity, thus individual donors are given recognition for their donation amounts.

In the event that the account type is a custodial back account, the first step is that the system consolidates donations by recipient, step 234. In this case, the giving platform aggregates various donations from multiple users into charity-specific allocations. The system therein cuts checks to the recipient organization, step 236, which as noted above can include an actual check or may include a wire transfer. Thereupon, the system in step 238 notifies recipient organization of gross and net contribution per member.

Regardless of the type of account, the outgoing fund allocation therein provides, step 240, that the member account shows processing of donation and consolidation of tax reporting. As described in further detail below, the user is presented with tax reporting for annual charitable donations, usable not only for internal record keeping, but also for reporting tax deductions for charitable giving.

The giving platform provides a centralized platform for embracing various sources and charities, which enhances or encourages charitable donations. The management of charitable donations improves donations by presenting new means for charitable donations and improved efficiencies for connecting donors and charities.

While the giving platform provides for the facilitation of funds to charities and allowing donors improved access to giving said funds, the giving platform further allows for the determination of the influence of the user in the giving community, as well as to the charities and causes. The giving platform further includes an influence engine including functionality via executable instructions for generating a complete picture of the donor's giving habits. Based on the influence engine, these habits can be visually realized by a graphical user interface.

As noted above, the computerized processing method may include collecting donation activity information of a user and scoring the donation activity information. The gift processing system may comprise an influence engine for determining a donor influence rating of the user as a function of the scored donation activity information. In the influence engine, the giving platform may thus collect the sum of information about the philanthropic activities of an individual (including user interaction via the system with a charity) and capture that collection in the form of an influence rating. In one embodiment, the rating is a collection or measure of information scores about donations (transactions and dollar amounts), invitations and sharing (social interaction) with friends, participation in campaigns (number of events and dollars raised), partner interactions (number of transactions, number of partners, and dollars earned into the giving account), and user volunteer activity (hours report, number of events, number of organizations supported, types of charities). The above list is exemplary in nature and it is recognized that further information may be utilized, or elements from the list may be omitted or prioritized as desired. Regardless of the specific factors, the influence engine utilizes the factors or scores to determine customer or user recognition, as well as user engagement with charities, for example. In one embodiment, the algorithm may apply a weighting to the various factors, such as a weighted logarithmic sum, to determine a score for each factor and then generate a composite number or donor influence rating. Scoring may be used to monitor desired activities. For example, an increasing level of activity within a single factor may return a score per activity that decreases (e.g., a first donation scores 250 points, while a second scores 50 points. However, an increasing level of activity within a plurality of factors may return an increasing score. FIG. 13 is an illustration of an embodiment of an influence scoring scheme. Scale 1301 shows that each occurrence of an action is additive on a logarithmic scale with a maximum score (e.g., 500). Plus signs 1302 illustrate that three factors or different activities are summed with a Comparative Community Score to create a final Influence Score, here being a maximum of 2,000. The Comparative Community Score is shown by 1303. A Comparative Community Score can create a geometric return on the percentile that user falls into, when compared to the influence of the community, thus creating higher returns the more influential the user may be by comparison. This composite donor influence rating may then be compared to other users, where the graphical user display provides a display of the user's influence number, as well as where the user ranks, or is positioned relative to the user giving platform users. An influence engine may also consider a user's influence in the context of the influence of a particular community, within a particular community, or relative to a particular community. In some embodiments, a user's donor influence rating may be provided to a third-party, such as one participating with the gift processing system by incorporating a processing module in the third-party's commercial transaction web interface.

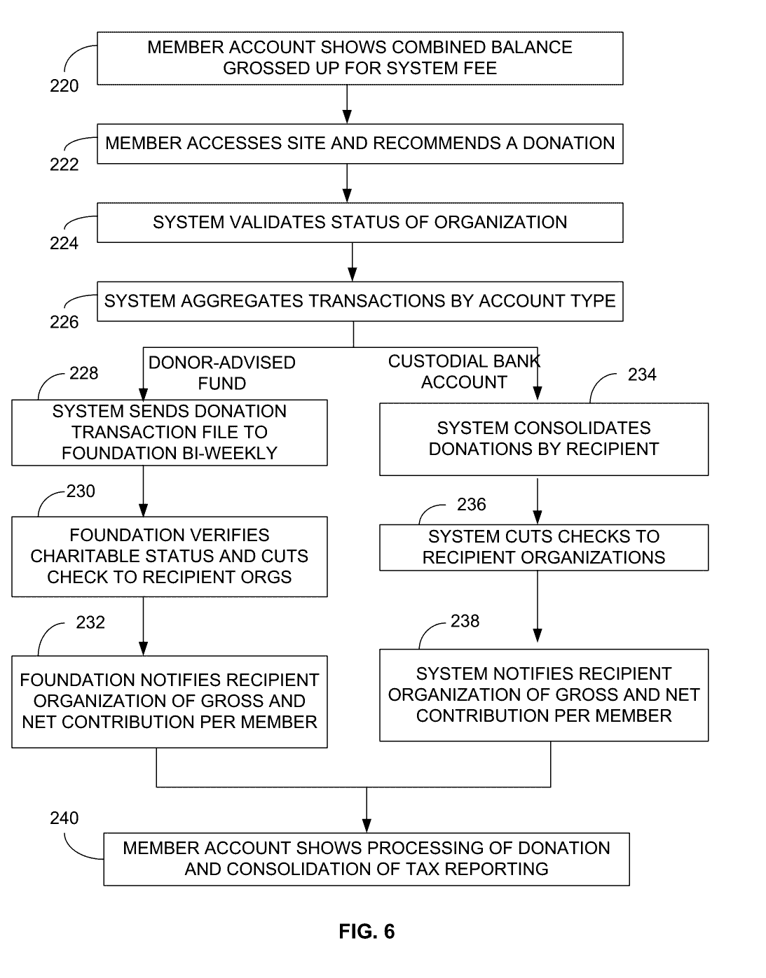

FIG. 7 illustrates a graphical representation of the various parties actively engaging or benefiting from the giving platform. In the illustration, the giving platform and system 240 provide a central interface for various charitable recipients, such as schools and universities 242 and other charities 244. The platform and system 240 further connect users either directly or through commercial transactions. Exemplary providers allowing for user donation activities include retailers 246, currency-based loyalty program providers 248, employers 250, employee benefit providers 252 and financial service providers 256.

The third-party retailers 246 may include either direct (offline) point of sale transaction capabilities, or in another embodiment may offer online transactions via the third-party's commercial transaction web interface, (i.e., including various applications or other functional software to allow a user to make a donation online), either with or independent of a commercial transaction. For example, a retailer may be affiliated with a charity 244 or a nearby school or university 242 (sometimes generically referred to as a charity), such that while visiting a physical location, such as a retailer's store, or an online web site, the user may donate funds. For clarity, however, in general a third-party retailer would not be the same party as that hosting a charity server. Instead, in an online transaction example, the user could add a donation amount to the commercial transaction, or in another embodiment, select a donation button to execute a separate transaction. Similarly, in a physical retail setting, the user may select to add a donation amount to the transaction. Once the donation amount is selected, the retailer 246 can then process the donation via the giving platform and system 246. In a point of sale transaction, the point of sale processing system may redirect the donated funds to the system 240, with user indication so it is allocated to the user's account. In another example, the user may be presented with a multi-digit reference number that the user may manually enter into the giving platform and system 240 to claim the allocated transaction. In an online transaction, the user may already have electronic access to their giving platform account via a preserved state tool, cookie, or other type of embedded software, the user may be redirected to log in to the platform account, or other techniques may be envisioned. Thus, the third-party retailer provides an electronic trigger or conduit to (i) receive donation funds, (ii) transfer the funds, and (iii) allow for user-specific account or charity allocation of funds on the giving platform. Similarly, specifically designated or earmarked funds can be so noted for subsequent transfer to the allocated charity. The giving platform 240 therein provides a centralized platform to allow a retailer to increase charitable donations for good causes, more readily facilitating its customers to contribute to retailer-selected charities, and efficiently managing the charitable activities of the user.

In the example of currency-based loyalty programs, the third-parties, such as vendors or providers, typically offer cash-back or other type of return of currency to the user for using a credit-card or other type of card-based transaction. The user can accumulate these currency benefits, e.g. cash, in the user's account with the loyalty provider. Thus, the loyalty provider can provide a direct access to charitable giving to the user via the platform 240. The user can allocate the currency reward as a plurality of donation funds to the user's donation/giving account, and then conduct the donation as the user wishes. In this case, the loyalty provider can provide an electronic transfer of funds through a clearinghouse or other financial transaction to effectively transfer the rewards to the platform 240, with the platform 240 then allocating funds to the user's giving account within the computerized gift processing system. In one embodiment, the user may conduct these transactions online via a software application running on the user's computer or on a server via the Internet, where the user is able to access the rewards currency and then transfer the funds to the platform 240. For example, the third-party provider may include a direct link as a processing module for the user to transfer the currency to the platform 240, or in another example the platform may include functionality within a web interface for the user to enter the reward account information and the platform can then retrieve the currency and deposit into the user's giving account.

For employers 250, the system may allow for the seamless transition of charitable giving programs via payroll or other types of employee distribution systems. In this case, the employer may include, either directly or via a payroll system, the ability to allow a user (i.e., employee) to allocate a certain percentage of funds for donating. The payroll system can then automatically process those funds from all such employees during a payroll period and distribute the funds to the platform 240. The platform 240 also receives allocation amounts to thus distribute the funds to the various users' donation giving accounts. The platform 240 provides a seamless interface for the employer offering charitable giving benefits, as well as an automatic processing avenue for the user to have income allocated to their giving accounts.

Similar to employers, employee benefit providers 252 may also seamlessly provide for accounts or donation funds to the user's giving account. In one embodiment, employers may include a charitable giving matching program, where the employer matches charitable donations up to a certain amount. Again, the utilization of the platform and system 240 provides a centralized electronic platform for ease of donating funds to the platform, and for ease of users to then donate and distribute such funds to charities.

Another optional example of a donation funds source are financial service providers. For example, users may wish to electronically transfer money from existing accounts, e.g. checking, savings, etc., for the purpose of making donations. The financial service providers may also include tax planning services as well as holding of financial reserves. For clarity, such accounts held by the financial service provider are not the same thing as the user's giving account within the gift processing system.

With financial service providers, electronic access with the platform 240 allows for direct transfer of funds from the user's financial service account to the user's giving account. In one example, software embedded within or executed concurrent with the financial service provider may allow for the user to either link their giving account information or be remotely logged in to the giving account. The user can then effectuate an electronic transfer of funds to their giving account, in one embodiment, from within the interface of the financial service provider, or with another embodiment being from within the giving platform having remote access to the financial service provider's account (or the financial account), or in another exemplary embodiment affixing giving account reference information to the transfer of funds and performing a funds transfer operation using a third party or clearinghouse operation.

The giving platform includes various embodiments, as noted herein. These embodiments are operational via computer processing operations performed by one or more processing devices in response to executable instructions.

One embodiment includes referrals for customers or other users. In one embodiment, this feature may only be available to log in (i.e., or registered) members, including the function of asking do you want to refer a friend. If yes, open a blank email and, with pre-population of text and link with reference code, while also allowing for some personalization of the email. The system may then send the email or other communication. The recipient clicks through email and enrolls (e.g., by a processing module). An enrolled member ID may be saved as a token/affiliate of the referring member. If email is bounced back, there is no notification to the member doing the referral. In one embodiment, there is no reporting to the member of the list of responses, whereas in another embodiment a thank you email is sent for each referral to the member. The system may also show referral count on the site (i.e., optionally as activity information), post referral incentive transaction, if applicable, to account of the referring member and the new member's account once they have made a contribution to their new account and/or assign a promo code to each referral campaign to allow for message and incentive testing. Incentives for referrals may be a fixed dollars/cents per member or a percentage of the amount donated by the newly acquired member. A cap on the amount that can be earned per member for referrals per campaign may be required, for some models. Incentives will only be earned after the new member completes a contribution or donation through his/her account, for such embodiments.

There is also the invitation process for new users. This invitation process may be similar to referral but differs in that there may not be an incentive, and it can be done from the site or by forwarding emails or other messages from the giving platform.

Another embodiment aspect relates to campaigns. The giving platform may provide multiple labels/sections on the site link to the same functionality. Financial goal of a campaign does not trigger a donation or close of campaign. The system also allows for personal fundraising, including creating a campaign for an individual. The user may select a cause. The user who creates the campaign is the administrator and can select a timeframe for the campaign. In one embodiment, there is a page for the campaign event—with its own content. The user may upload email addresses, provide standard text that can be personalized with link to the campaign and notify contacts—members and non-members. The giving platform creates a holding account for donations. Nonmembers must enroll in the giving platform to donate and can include an auto process a transfer of funds from the user's giving account to campaign balance amounts.

In the user accounts, the platform may also show pending transaction on member account. This includes an administrator processes gifts, including donation transactions in member accounts move to complete where the charity gets same reporting as usual but gets additional info on those that participated in a specific campaign. If there is a referral promotion available, new members solicited in the campaign are eligible for the referral promotions

For a group gift, the user or group of users can select a cause. Member who creates the campaign is the administrator. There is a page for the campaign event—with its own content. The platform creates a holding account for donations. Nonmembers must enroll in the platform to donate and the system auto processes a transfer of funds from giving account to campaign balance.

Another embodiment relates to a family foundation via the giving platform. Users select a cause. The member who creates the campaign is the administrator. There is no time limit to the campaign and there is a page for the campaign, with its own content. The platform creates a holding account for donations. Nonmembers must enroll in the platform to donate and the system can auto process a transfer of funds from the account to campaign balance, including show pending transaction on member accounts. The Administrator processes gifts, including donation transactions in member accounts move to complete and charity gets same reporting as usual but gets additional info on those that participated in a specific campaign.

Another embodiment relates to a kids place in the giving platform. Parent creates kids as authorized users on the parent account, including confirmation and conformance with any child online privacy protection laws or regulations. Kids cannot process a donation without parent approval. In one embodiment, the balance is a virtual dollar amount and can have their own page and balance. Kids create their own favorites, can upload their own content on the platform. This embodiment may include updated or modified user interfaces being kid-friendly.

In the giving platform, users may make contributions in any number of forms. One embodiment provides for personal contributions, including payroll. A file includes employee name, address, email, phone, employee/payroll ID, employer ID, contribution amount, date. The system may also request employment status—termination file. The system can then perform an ACH transfer from Employer to the platform via the bank, a reconciliation process to match the deposit with the batch file and begin with manual verification of the batch process. The system may then post contributions to the members' accounts based on payroll file. Exceptions can include existing users now participate in payroll deduction, where this can trigger for email verification is a change in the content employee ID field. A match may be based on email on the system and verification with employee 1D. The system may require a personal email addition only for employers to ensure portability later. Employee will manually enter employee ID to confirm accounts matched appropriately.

For employee contribution, there may be unidentified accounts for new people. The giving system may operatively create the account on the fly, trigger for verification is a change in the content employee ID field and each new account will have to verify email as described in member management.

For closed accounts, member has initiated closure of their giving platform account. In this embodiment, the system can then reject account contribution from employer and the system may manually or electronically return funds to client and tell the client.

For accounts with no contributions, a process occurs after first missed transaction. This process may include sending an email message to member, report-contribution change report that shows members previously contributing that have stopped. The client (employer) may then confirm the person has stopped contributing, employment has terminated, or that transactions are missing/something. The system can also provide the ability for the employer to send one file with all three contribution types—payroll, foundation, and matching. The system may use Credit/Debit/ACH. For example, recurring contributions can be on a regular frequency, such as 15th or 30th of every month, last day of the calendar quarter. The system may include no minimum contribution but may also reserve the right to create a minimum for specific payment types.

Moreover, employers may restrict how their dollars may be donated by suppressing at the category level—charities, churches, and schools. In one embodiment, partners will default to no restrictions. Restricted employer contributions can be kept and shown separate from personal contributions.

For Employer Contributions, non-payroll, these contributions may be via a foundation. Employer will determine employee eligibility requirements and contribution amount. File will include employee name, address, email, phone, employee/payroll 1D, employer ID, contribution amount, date. The system may follow the same path for existing members, Unidentified Accounts, and Closed Account exceptions. The Accounts with no contributions exception is not applicable.

For contribution matching, Employer will determine employee eligibility requirements and contribution amount. File will include employee name, address, email, phone, employee/payroll ID, employer ID, contribution amount, date. The system can follow the same path for existing members, Unidentified Accounts, and Closed Account exceptions. The Accounts with no contributions exception is not applicable.

Another feature of the giving platform is a function for Retailer/Loyalty Program Contributions. Enrollment and initial contribution are described in Member Management section on the user interface, allowing for guidelines and instructions for users and program partners to facilitate the transactions. These may include the electronic transfer and communication with the partner promotion systems, typically these promotion systems executed by third-party vendors. For example, a user may log a rewards account and the rewards provider, such that the giving platform can establish and verify the account, receive the contributions and provide proper accounting with the entity providing the rewards. On-going contributions will work the same way for spend promotions and loyalty programs are managed in the same way as the enrollment/initial contributions.

For shopping partner Contributions/Affiliate Marketing, the giving system can also coordinate such donation efforts. One embodiment includes online mall, which can use an affiliate model (i.e. Linkshare). Establish a temp ID that is passed (API) to online mall provider. Temp ID is tracked by provider and sent back to us with confirmed transactions. Batch file of completed transactions with Temp ID is sent back to giving platform and posts transactions to member's account.

For brick and mortar (offline/retail) shopping partners, the platform may register a card on the platform and batch registrations to (Affinity Solutions) Golden Retriever Systems. The giving platform ID is passed to provider. That ID is tracked by provider and sent back with confirmed transactions. Batch file of completed transactions with giving platform ID is sent back to the platform. The system then posts transactions to member's account.

In the giving platform, there is an online donation data and currency flow. This process includes follow website flow of user instructions and menus/submenus of interactivity. The user then enters billing information and provides options to save account for future donations.

In addition, the system can provide mobile donation flow. These user operations can include look up my account; see balance; search or select favorite; process donation the same way; do not include gifts, in memoriam, or recurring donations; allow for anonymous donations; and/or get email confirmation.

The system may store user account information and in the mobile platform, allow for account on File (Linked Accounts)/Pull Through transactions. Profile management includes that the user can link an account. This allows for storage of multiple accounts. Same process is usable for online and mobile channels.

When account has insufficient balance during the donation transaction, check for linked accounts on file. If yes, proceed as below. If no, redirect to add funds web page first. Calculate the difference between funds available and donation amount and charge the difference to the account on file. The system may then tell the customer on the donation checkout page: You need to add funds to your account and you have linked accounts, would you like us to bill the difference to your account on file. If yes, proceed. Select the account on file from which you want to fund the difference. This may include display language—you are authorizing a transaction from your account, donations are non-refundable, etc. Then, complete check out.

If no, do you want to proceed with donating the balance of your account? If yes, proceed with balance. The system can then display language—you are authorizing a transaction from your account, donations are non-refundable, etc. Complete check out. If no, return them to another page. This process applies to both one-time and recurring donation transactions.

Another aspect of the giving platform is charity verification. One embodiment may use a charity verification service, such as those available by GuideStar USA, Inc. under the GuideStar® name. Functions may include a charity check, update of cache daily, or a check of charity status in real-time during donation. A “Favorites” feature management process may also be included, any charities removed from good standing will be removed from “Favorites.” The system can notify member via email or other messaging mode that favorite is no longer available.

Funds donated to these charities may be lost if made in between the donation processing cycle (check already issued) and the update from a charity verification service. Thus, financial reconciliation may include bank account management. This can include a procedure that funds from contributions are deposited in holding accounts. An accounting system calculates a fee to each deposit, such as in one embodiment a fee of 5.5%. The system may manually move the fee percentage to the operating account, and manually transfer remainder of funds to sweep account. A sweep account is an account where donations reside until donation directions are received.

Another aspect of giving is the correlation of the act of giving to social media outlets and promotions. In one embodiment, the giving platform may provide a news feed on the dashboard page for the social media site. The news feed can include giving platform content and user content only. The giving platform may host its own social media platform or in alternative embodiments may interact and cross-populate information with other social media platforms.

For example, via the social media sites, the user may increase community and personal fundraising. This can be accomplished by not only cause-promotion, but also distribution of information to other users. The postings may include additional comments or following, to further expand the scope and reach of the social media interaction.

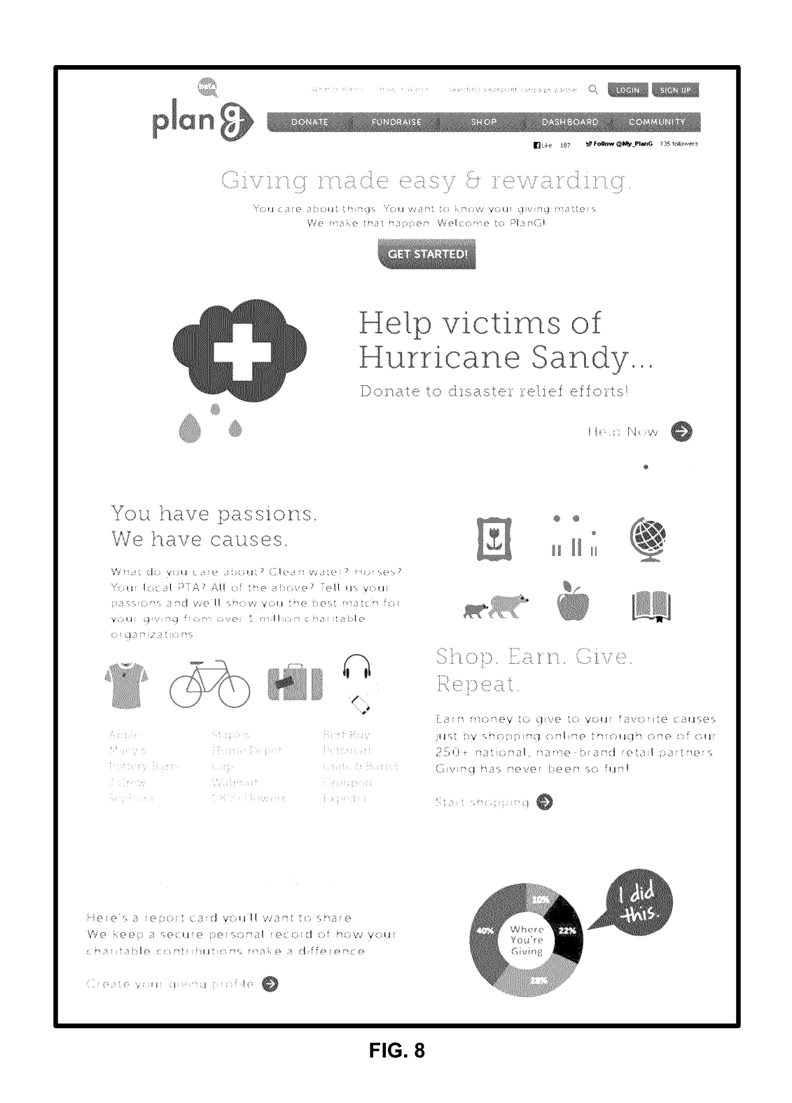

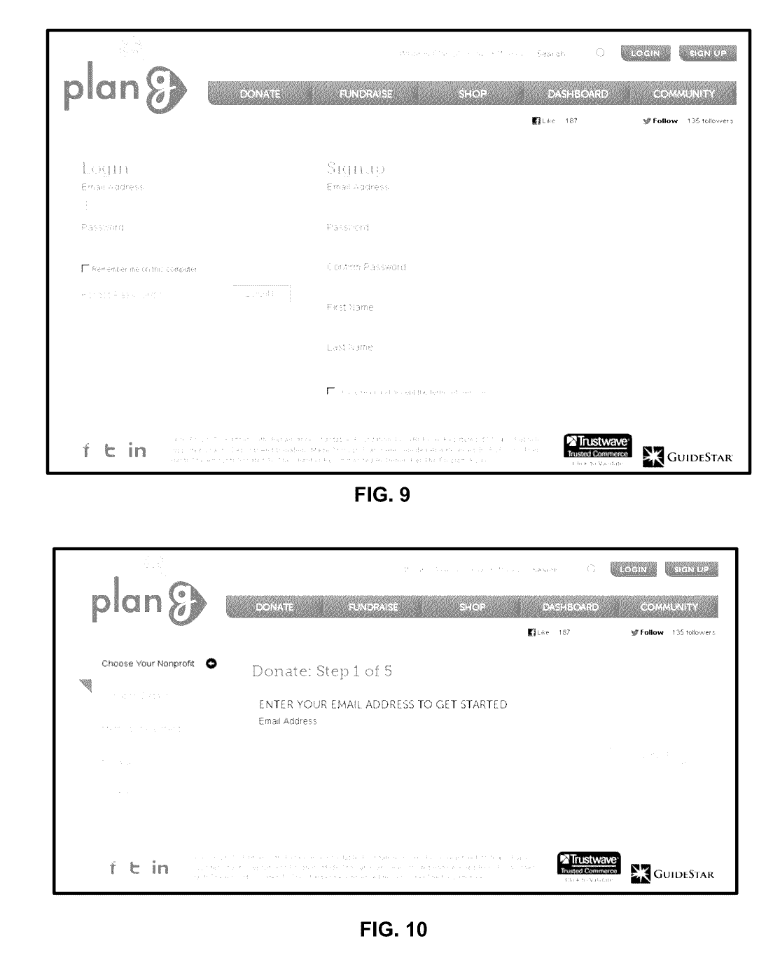

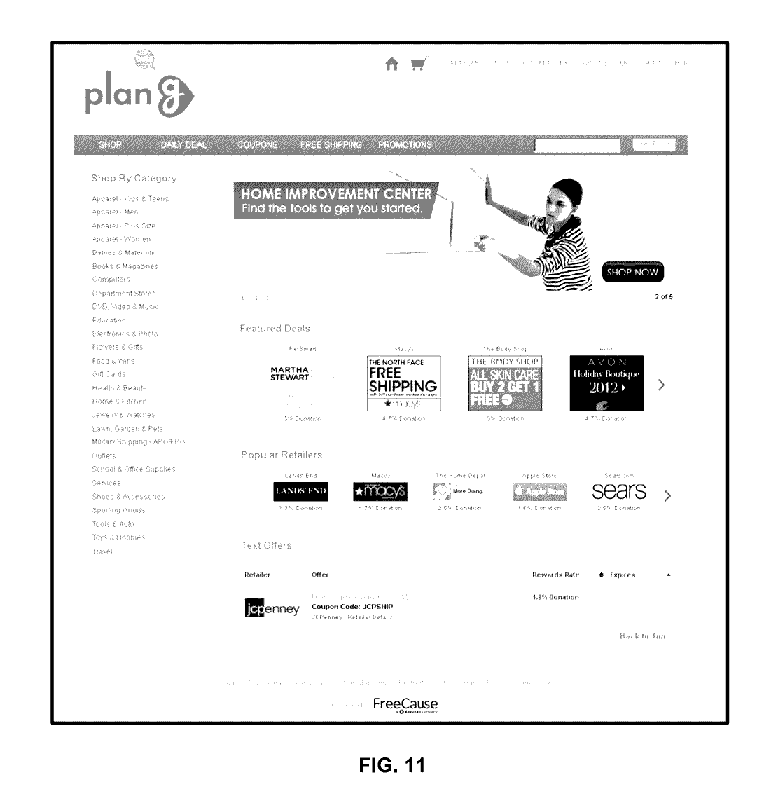

The user may also seek to establishing preferences to which social media sites for sharing information. Additionally, the system can provide the ability to check which social media sites you want to post to when you post a comment. For further illustration of the interface and user interactivity of the giving platform, FIGS. 8-12 provide sample screenshots of various embodiments of the giving platform. FIG. 8 illustrates a screenshot of a general description of the giving platform to users, as well as indicating how to increase donation and track charitable giving. FIG. 9 illustrates a sample sign-up screen allowing users to generate a donation account. FIG. 10 illustrates a first screen in a donation process.

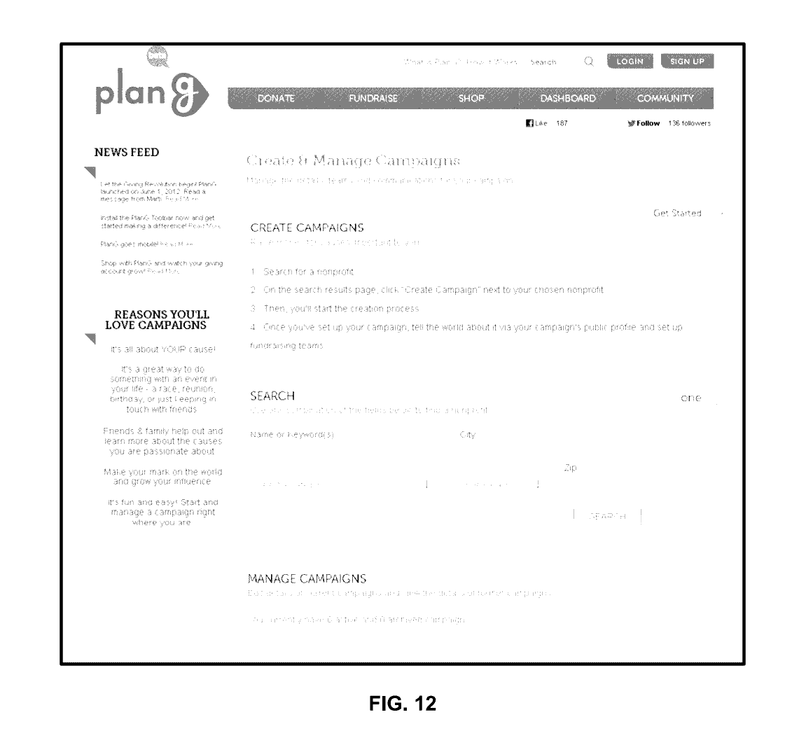

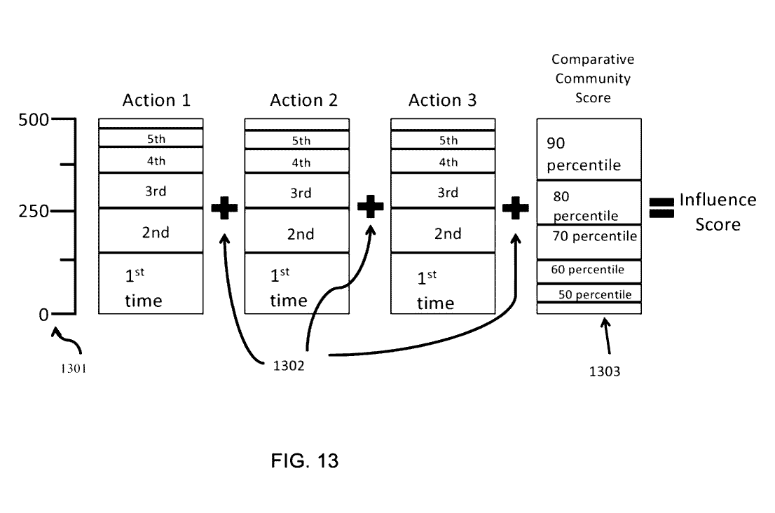

The giving platform further includes commercial transactions and retailer benefits. FIG. 11 illustrates an example of various retailer offers and deals. FIG. 12 illustrates an example of a campaign management screen, allowing for a user to generate a donation campaign.

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized processing method for managing charitable donations from a donating user, the method comprising:
providing a graphical user interface to the user by a computerized gift processing system, wherein the gift processing system comprises an influence engine;
creating within the gift processing system a giving account associated with the user and granting the user electronic access to the giving account via the graphical user interface;
displaying within the graphical user interface a plurality of charities;
receiving by the computerized gift processing system a first plurality of donation funds from the user for allocation to the giving account of the user, such that the giving account includes the first plurality of donation funds; electronically receiving in the computerized gift processing system a donation request from the user to generate a donation to a user selected charity from the plurality of charities, the donation providing a donation value of at least a portion of the first plurality of donation funds within the giving account;
electronically processing the donation including transferring, via the computerized gift processing system, the donation value to the selected charity;
updating the giving account of the user to reflect the allocation of donation funds to the selected charity;
collecting donation activity information of the user;
scoring the donation activity information of the user; and
determining via the influence engine a donor influence rating as a function of the scored donation activity information.

2. The method of claim 1, wherein the determining of the donor influence rating is by a weighted logarithmic sum.

3. The method of claim 1, further comprises:
facilitating through the computerized gift processing system in electronic engagements between the user and the selected charity via the graphical user interface; and wherein the donation activity information comprises information about the electronic engagements between the user and the selected charity.

4. The method of claim 1, wherein the plurality of charities comprises at least one recommended charity determined as a function of the donation activity information of the user.

5. The method of claim 1, further comprising:
providing a processing module to a third-party having a commercial transaction web interface, the processing module enabling the user to access at least a portion of the graphical user interface of the gift processing system from the third-party's commercial transaction web interface;
receiving by the gift processing system a second plurality of donation funds from the user via the user performing a processing transaction on the third-party commercial transaction web interface, such that the giving account includes the second plurality of donation funds;
electronically receiving in the computerized gift processing system a donation request from the user to generate a donation to a user selected charity from the plurality of charities, the donation providing a donation value of at least a portion of the first and second plurality of donation funds within the giving account.

6. The method of claim 5, wherein the method further comprises the step of providing the donor influence rating to the third-party.

7. The method of claim 5, wherein at least a portion of the second plurality of donation funds is supplied by the third-party on behalf of the user.

8. The method of claim 1 further comprising:
wherein the receiving of the first plurality of donation funds from the user for allocation to the giving account of the user, is by electronic transfer from a bank account associated with the user.

9. The method of claim 7 further comprising:
wherein the portion of the second plurality of donation funds supplied by the third-party is via one or more third-party reward accounts offered by the third-party to the user.

10. The method of claim 1 further comprising:
wherein the receiving of the first plurality of donation funds from the user for allocation to the giving account of the donor is by electronic transfer from an employer of the user.

11. The method of claim 7, wherein the third-party is not a financial services provider and the commercial transaction web interface is a retail electronic commerce website.

12. The method of claim 11 wherein the processing transaction on the third-party commercial transaction web interface is an online purchase by user of a product.

13. A computerized system for managing charitable donations of a donating user, the system comprising:
a non-transitory computer readable medium having executable instructions stored thereon; and
a processing device, in response to the executable instructions, operative to:
provide a graphical user interface to the user by a computerized gift processing system, wherein the gift processing system comprises an influence engine;
create within the gift processing system a giving account associated with the user and grant the user electronic access to the giving account via the graphical user interface;
display within the graphical user interface a plurality of charities;
receive by the computerized gift processing system a first plurality of donation funds from the user for allocation to the giving account of the user, such that the giving account includes the first plurality of donation funds;
electronically receive in the computerized gift processing system a donation request from the user to generate a donation to a user-selected charity from the plurality of charities, the donation providing a donation value of at least a portion of the first plurality of donation funds within the giving account;
electronically process the donation including transferring, via the computerized gift processing system, the donation value to the selected charity;
update the giving account of the user to reflect the allocation of donation funds to the selected charity;
collect donation activity information of the user;
score the donation activity information of the user; and
determine via the influence engine a donor influence rating as a function of the scored donation activity information.

14. The system of claim 13, wherein the influence engine determines the donor influence rating by a weighted logarithmic sum.

15. The system of claim 13, wherein the processing device, in response to the executable instructions, is further operative to:
facilitate through the computerized gift processing system in electronic engagements between the user and the selected charity via the graphical user interface; and wherein the donation activity information comprises information about the electronic engagements between the user and the selected charity.

16. The system of claim 13, wherein the plurality of charities comprises at least one recommended charity determined as a function of the donation activity information of the user.

17. The system of claim 13, wherein the processing device, in response to the executable instructions, is further operative to:
provide a processing module to a third-party having a commercial transaction web interface, the processing module enabling the user to access at least a portion of the graphical user interface of the gift processing system from the third-party's commercial transaction web interface;
receive by the gift processing system a second plurality of donation funds from the user via the user performing a processing transaction on the third-party commercial transaction web interface, such that the giving account includes the second plurality of donation funds;
electronically receive in the computerized gift processing system a donation request from the user to generate a donation to a user selected charity from the plurality of charities, the donation providing a donation value of at least a portion of the first and second plurality of donation funds within the giving account.

18. The system of claim 17, wherein the processing device, in response to the executable instructions, is further operative to provide the donor influence rating to the third-party.

19. The system of claim 17, wherein at least a portion of the second plurality of donation funds is supplied by the third-party on behalf of the user.

20. The system of claim 13 wherein the processing device, in response to the executable instructions, is further operative to receive the first plurality of donation funds from the user for allocation to the giving account of the user by electronic transfer from a bank account associated with the user.

21. The system of claim 19 wherein the portion of the second plurality of donation funds supplied by the third-party is via one or more third-party reward accounts offered by the third-party to the user.

22. The system of claim 13, wherein the processing device, in response to the executable instructions, is further operative to receive the first plurality of donation funds from the user for allocation to the giving account of the donor is by electronic transfer from an employer of the user.

23. The system of claim 19, wherein the third-party is not a financial services provider and the commercial transaction web interface is a retail electronic commerce website.

24. The system of claim 23, wherein the processing transaction on the third-party commercial transaction web interface is an online purchase by user of a product.

25. A computerized system for managing charitable donations from a donating user, the system comprising:
a non-transitory computer readable medium having executable instructions stored thereon;
and a processing device, in response to the executable instructions, operative to:
provide a graphical user interface for access to a computerized gift processing system, wherein the gift processing system comprises an influence engine;
display within the graphical user interface a plurality of charities;
provide a processing module to a third-party for use in a commercial transaction with the user, the processing module enabling the user to access at least a portion of the graphical user interface of the gift processing system;
receive by the gift processing system a first plurality of donation funds from the user via the user performing a processing transaction with the processing module, such that the giving account includes the first plurality of donation funds;
electronically receive in the computerized gift processing system a donation request from the user to generate a donation to a user-selected charity from the plurality of charities, the donation providing a donation value of at least a portion of the first plurality of donation funds within the giving account;
electronically process the donation including transferring, via the computerized gift processing system, the donation value to the selected charity;
update the giving account of the user to reflect the allocation of donation funds to the selected charity;
collect donation activity information of the user;
score the donation activity information of the user; and
determine via the influence engine a donor influence rating as a function of the scored donation activity information by a weighted logarithmic sum.

26. The system of claim 25, wherein the processing device, in response to the executable instructions, is further operative to:
provide the user access to the graphical user interface without use of the processing module;
create within the gift processing system a giving account associated with the user and grant the user electronic access to the giving account via the graphical user interface;
receive by the computerized gift processing system a second plurality of donation funds from the user for allocation to the giving account of the user, such that the giving account includes the first and second plurality of donation funds;
electronically receive in the computerized gift processing system a donation request from the user to generate a donation to a user-selected charity from the plurality of charities, the donation providing a donation value of at least portion of the second plurality of donation funds within the giving account.

27. The system of claim 25, wherein the processing device, in response to the executable instructions, is further operative to provide the donor influence rating to the third-party.

28. The system of claim 25, wherein the commercial transaction is an offline purchase by user of a product.
